(19) United States
(12) Patent Application Publication
(10) Pub. No.: US 2025/0155905 A1
(43) Pub. Date: May 15, 2025

(54) Device and Computer-Supported Method for Determining a Control Protocol for a Microfluidic System

(71) Applicant: Robert Bosch GmbH, Stuttgart (DE)

(72) Inventors: Anja Lippert, Leonberg (DE); Aaron Doerr, Leonberg (DE)

(21) Appl. No.: 18/834,153

(22) PCT Filed: Jan. 26, 2023
(86) PCT No.: PCT/EP2023/051883

§ 371 Date: Jul. 29, 2024

(30) Foreign Application Priority Data
Feb. 3, 2022 (DE) 10 2022 201 124.4
Jan. 25, 2023 (DE) 10 2023 200 557.3

(51) Int. Cl. G05D 23/19; B01L 3/00

(52) U.S. Cl. CPC G05D 23/1917; B01L 3/502715; B01L 3/50273

(57) ABSTRACT

A device is for determining a control protocol for a microfluidic system using temperature influences. The microfluidic system includes a first chamber for a fluid, and a first heating element configured to influence a temperature of the fluid in the first chamber. A model is provided which is parameterized with a parameter set, and which is configured to determine an influence of a first temperature and an influence of a second temperature on a temperature profile in the fluid in the microfluidic system, if same is controlled according to the control protocol. A target is provided for the temperature profile. The parameter set is determined at which a temperature profile calculated with the model fulfills the target. The parameter set comprises at least one parameter of the control protocol which specifies the first temperature and/or the second temperature.

### PRIOR ART

The specification proceeds from a method for determining a control protocol for a microfluidic system. Microfluidic systems permit decentralized analysis of patient samples by means of modern molecular diagnostic methods, for example for performing a PCR test for the detection of pathogens. For highly reliable and fully automated performance of biomechanical process flows and targeted thermal manipulation of sample liquids in such systems, both a suitable design of the structures and suitable performance of the process steps are generally necessary to ensure the desired functionalities.

### DISCLOSURE OF THE INVENTION

The desired functionality is particularly efficiently achieved by the subject matter of the independent claims.

According to the independent claims, a prediction for a control protocol is determined with which a predetermined temporal temperature profile, i.e., a target, is achieved. The prediction avoids or at least saves costly experimental iterations that would otherwise be almost impossible to carry out in parallel. As a result, significantly fewer computing resources are required to determine the control protocol for controlling microfluid systems.

This is achieved with a computer-supported method for determining a control protocol for a microfluidic system using temperature influences, wherein the microfluidic system comprises a first chamber for a fluid, wherein the microfluidic system comprises a first heating element which is designed to influence a temperature of the fluid in the first chamber, wherein a model is provided which can be parameterized with a parameter set, and which is designed to determine an influence of a first temperature and an influence of a second temperature on a temperature profile in the fluid in the microfluidic system, if same is controlled according to the control protocol, wherein a target is provided for the temperature profile, wherein the parameter set is determined at which a temperature profile calculated with the model fulfills the target, wherein the parameter set comprises at least one parameter of the control protocol which specifies the first temperature and/or the second temperature. This allows the temperature control in a chamber to be switched between two temperatures in the cycle. The control protocol may provide for a third temperature or more than three temperatures in the cycle.

The microfluidic system preferably comprises an analysis device into which a cartridge for analysis of the fluid in the cartridge may be received, wherein the cartridge can be part of the microfluidic system and can comprise the first chamber described above, while the analysis device preferably comprises the first heating element. According to a particular embodiment, the cartridge can comprise further passive parts, such as channels, chambers and controllable (membrane) valves and pump chambers, while the analysis device can comprise active components for processing the cartridge, for example heaters, pumps, compressed air tanks and electronic components, such as processors and memories. Thus, the control protocol determined with the method according to the invention is preferably designed to control the analysis device for processing the cartridge. For example, the microfluidic system may be set up to perform molecular biological tests, in particular for isothermic or polymerase chain reaction-based duplication of nucleic acid portions, for example, for performing a (PCR) test to detect pathogens.

Preferably, the microfluidic system, preferably the cartridge, comprises a second chamber for the fluid, wherein the microfluidic system, preferably the analysis device, comprises a second heating element, which is designed to influence the temperature of the fluid in the second chamber, wherein the model is designed to determine an influence of the first temperature of the first heating element and an influence of the second temperature of the second heating element on the temperature profile in the fluid in the microfluidic system. The sample is thus evaluated in two chambers, preferably at different temperatures.

The temperature profile may be influenced by a choice of the chamber, a choice of the temperature in the chamber, and a dwell time of the fluid in the chamber. The time during which the fluid is in one of the chambers is comparatively small compared to the time for the fluid to move from one chamber to the other. The following parameters are particularly well-suited for simulating the temperature influences causing different control protocols on the fluid.

For example, at least one parameter of the parameter set is determined, which specifies an order in the control protocol in which the first chamber and/or the second chamber are used to influence the temperature of the fluid. These parameters specify the respective chambers to be used.

For example, at least one parameter of the parameter set is determined, which specifies a dwell time of the fluid in the first chamber and/or a dwell time of the fluid in the second chamber in the control protocol.

The simulation may provide that a plurality of candidates for the control protocol is determined wherein the candidate is selected as the control protocol from the candidates with which the target is achieved faster than with at least one of the other candidates. For example, the candidate with which the target is most quickly achieved is selected. This allows an optimum in terms of the duration of the process to be found much more reliably and quickly than by experimental means.

If a geometry of the microfluidic system with variable geometry, e.g., at least one chamber, can be changed, it can be provided that at least one parameter of the parameter set is determined, which specifies the geometry of the at least one chamber of the microfluidic system with variable geometry in the control protocol. A variable geometry can be understood in particular to mean a variable geometry of a chamber or a channel, for example by means of an at least partially movable wall, for example in the form of an extensible membrane, or a movable piston. As a result, the volume of the chamber or channel can be changed and/or a portion of the fluid in the chamber or channel can be moved, which in turn can influence the thermal conditions, for example a change in the heat capacity or the thermal resistance in the chamber or channel.

If a position of at least one heating element of the microfluidic system with the variable position is variable, it may be provided that at least one parameter of the parameter set is determined, which specifies the position of at least one heating element of the microfluidic system with the variable position in the control protocol.

It can be provided that at least one parameter of the parameter set is determined with which the temperature influence in the microfluidic system is determined. This means that a system behavior of the microfluidic system is learned.

To control the microfluidic system with the control protocol, it is determined with the method and the microfluidic system is controlled with the control protocol. The control protocol may be thus advantageously determined and subsequently the microfluidic system may be operated using this control protocol. The control protocol can advantageously be determined in advance, i.e., “offline”, in particular by another device, and the microfluidic system, preferably the analysis device, can then be operated with the control protocol.

The microfluidic system is controlled with the control protocol, for example, to set the first temperature on the first heating element and/or to set the second temperature on the second heating element.

For example, the microfluidic system is controlled with the control protocol to pneumatically push or suck the fluid into at least one chamber.

The microfluidic system is controlled with the control protocol, for example, to change the geometry of at least one chamber and/or to change the position and/or temperature of at least one heating element.

A device with which the advantage is achieved comprises at least one processor and at least one memory, which are designed to perform the method. For example, the device may be an appropriately programmed computer or part of a cloud computing solution.

In a particular embodiment, the device may correspond to the microfluidic system, in particular to the analysis device described above. According to this variant, both the determination of the control protocol according to the invention and the execution of the control protocol may be performed by the same device or at least by the same type of device.

A computer program that achieves the same advantage comprises computer-readable instructions that, when executed by a computer, cause the method to run.

Further advantageous embodiments will become apparent from the following description and the drawing. The drawings show:

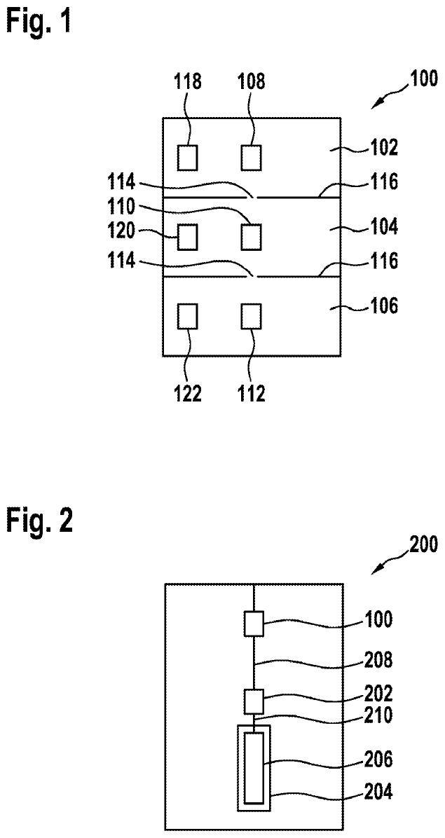

FIG. 1 a schematic representation of a microfluidic system,

FIG. 2 a schematic representation of a device,

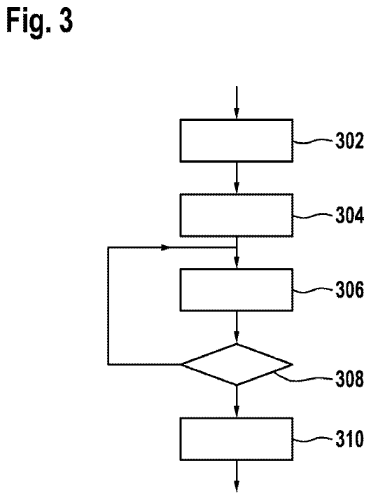

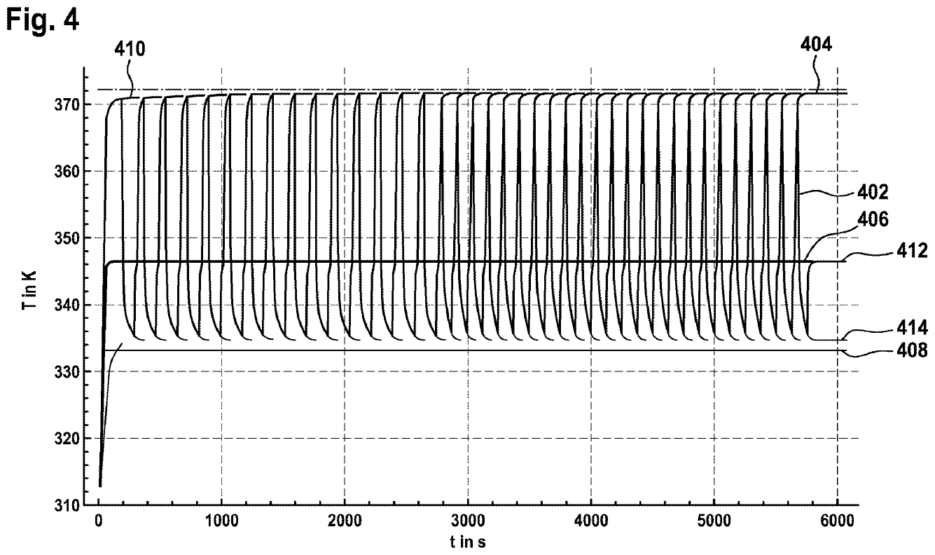

FIG. 3 a flow chart with steps in a method for determining a control protocol for the microfluidic system,

FIG. 4 a temperature profile in the fluid,

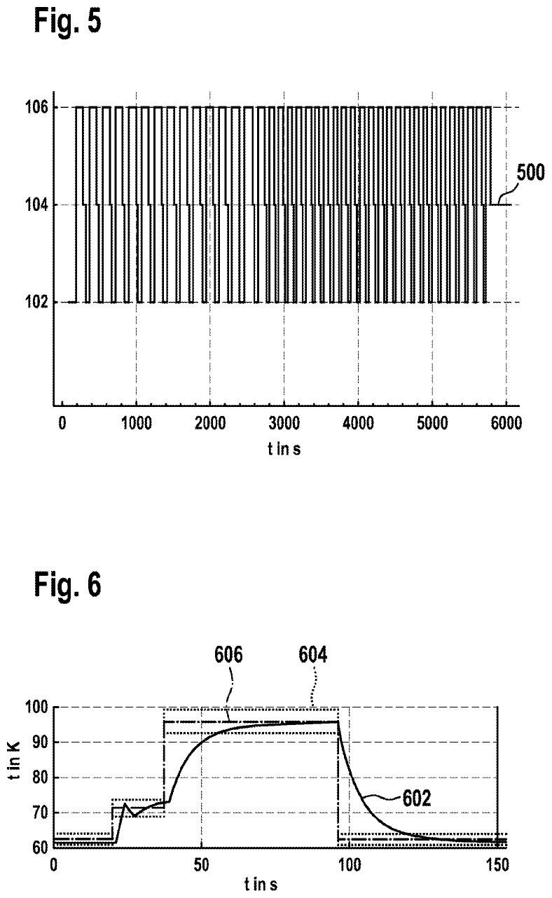

FIG. 5 an example flow control,

FIG. 6 a course of a fluid temperature in an example calculation,

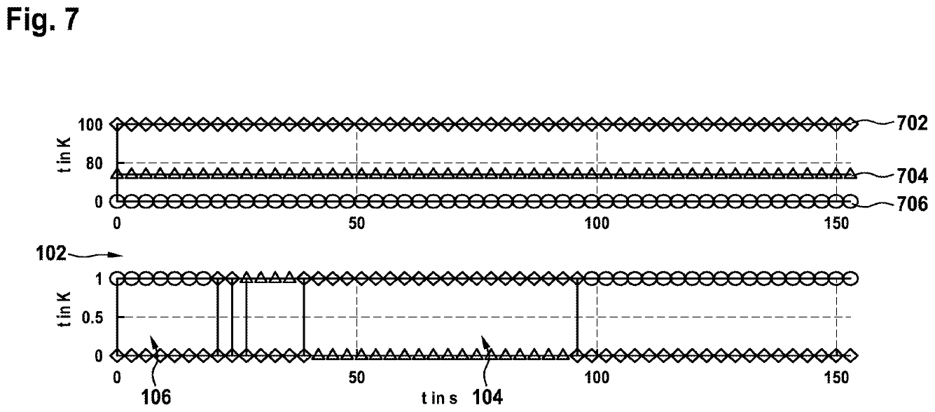

FIG. 7 a course of temperatures and dwell times of the fluid in the example calculation.

In microfluidic structures, sequential process steps are typically carried out in which a fluid, the sample fluid, is introduced into the microfluidic structure and prepared, and passes through a predefined temporal temperature cycle or several of these temperature cycles. In order to run through a prescribed sequential temperature sequence in a time-efficient manner, the use of multiple chambers, i.e. dwell chambers, which are at different temperature levels, has become established. Microfluidic structures are produced, e.g., as a cartridge with a plurality of chambers and under the influence of a plurality of heating elements, i.e. heaters.

When using heating elements and multiple chambers, sequential process management with one cycle sequence is possible. This should be as efficient as possible, i.e., to minimize the cycle length, for example, and to ensure an optimal biochemical reaction process.

Manual experimentation is time-consuming and cost-intensive and does not promise an optimum result. The procedure described below provides a prediction of a control protocol for a given temporal temperature profile provided without time-consuming experimental iterations that can hardly be carried out in parallel and, if possible, an optimum with regard to the sequence length, i.e., a duration of the procedure, can be found much more reliably and quickly than by experimental means.

In FIG. 1, a microfluidic system 100 is shown schematically.

The microfluidic system 100 comprises a first chamber 102 and a second chamber 104. It may be provided that the microfluidic system comprises more than two chambers. The microfluidic system, as exemplified in FIG. 1, comprises a third chamber 106. The approach described below works for one chamber, with two chambers and also with more than two chambers, in particular with three chambers as described in the exemplary embodiment.

The microfluidic system 100 comprises a first heating element 108 designed to influence a temperature of the fluid in the first chamber 102. The microfluidic system 100 comprises a second heating element 110 designed to influence the temperature of the fluid in the second chamber 104. It may be provided that the microfluidic system comprises more than two heating elements. The microfluidic system, as exemplified in FIG. 1, comprises a third heating element 112. According to the preferred configuration, the microfluidic system 100 comprises an analysis device into which a cartridge for analysis of the fluid in the cartridge can be received, for example as described in DE 10 2016 222 075 A1 or DE 10 2016 222 072 A1. In so doing, the analysis device may comprise the heating elements 108, 110, 112 the processor and the memory, while the cartridge is preferably designed as a passive part for processing the fluid, and wherein during processing, the heating elements 108, 110, 112 may be brought into contact with the chambers 102, 104, 106. For example, the method presented is part of a method for performing a duplication of nucleic acid sections, for example a method for performing a PCR test, for example for detecting a pathogen in a sample.

A fluid opening 114 is arranged between each two of the chambers in a wall 116 separating these chambers from one another. In the example, a first actuator 118 is designed to suck fluid into the first chamber 102 or to push fluid out of it. In the example, a second actuator 120 is designed to suck fluid into the second chamber 104 or to push fluid out of it. In the example, a third actuator 122 is designed to suck fluid into the third chamber 106 or to push fluid out of it. Here, one or more of the actuators 118, 120, 122 may be set up to change the geometry of the first chamber 102 or the second chamber 104 for sucking in or pushing out, for example by actuating an extensible membrane, wherein the membrane may be part of one of the walls limiting the chambers 102, 104.

In FIG. 2, a device 200 is shown schematically. The device 200 comprises the microfluidic system 100. The device 200 comprises at least one processor 202 and at least one memory 204. A model 206 is provided in the at least one memory 204. The model 206 is defined by a parameter set. In the example, the parameter set is stored in the memory 204. According to one particular embodiment, the device 200 may comprise or be designed to control the microfluidic system 100. Alternatively, the device 200 as described above is an appropriately programmed computer that determines the control protocol, which is subsequently used for the operation of the microfluidic system 100. In the example, a control connection 208 at least temporarily connects the at least one processor 202 to the microfluidic system 100. In the example, the at least one processor 202 and the at least one memory 204 communicate via a data connection 210.

The device 200 is designed to perform a method described hereinafter. For example a computer program is provided which comprises computer-readable instructions which, when executed by the at least one processor 202, i.e., by a computer, performs the method.

In the following description, a method is described using the first chamber 102 and the second chamber 104 as examples. The method can be applied to microfluidic systems with more than two chambers. The method can be applied to microfluidic systems with more than two heating elements.

The method is designed to determine a control protocol for the microfluidic system 100 under temperature influences. Model 206 is used to simulate the temperature effects on the temperature of the fluid in the chambers caused by executing the control protocol in order to determine the control protocol.

The model 206 supports an application, in particular of new biochemical assays, by quantitatively utilizing a physically modeled relationship between a control of the microfluidic system 100 and a biochemically relevant fluid temperature to determine one or more control protocols. This quantitative, computer-based solution uses an optimization method in one example. As a result, a better solution is found more quickly than is possible in experimental iterations.

One reason for this is that non-intuitive and sometimes complex parameter combinations are tried out both in stochastic approaches, such as random search or Bayesian optimization, as well as in control engineering approaches, such as model predictive control.

Another reason for this is that the process can be parallelized, i.e., many parameter sets can be tried out at the same time, allowing more tests per time. Preferably, the method for multiple models 206 is performed substantially in parallel. The procedure for a model 206 is described below.

The microfluidic system 100, as described above in the example, comprises a cartridge in which the fluid represents a sample.

Such a computer-based process does not require any device-side capacity needed for other development tasks. For example, no analysis device is needed.

For a correct biochemical sequence in the cartridge, a prescribed temporal temperature profile must be maintained in the sample. For this purpose, the correct control protocol is determined automatically using the method. In the example, the control protocol is determined by an intelligent iterative solution of an inverse problem. In the example, a result to be achieved with the control protocol, i.e., a target, is known and the necessary control, i.e., the control protocol, is determined.

In a step 302, the model 206 that can be parameterized with the parameter set is provided parameterized in particular with an initial parameter set. The model 206 is designed to determine a control protocol and an influence of a first temperature of the first heating element 108 and an influence of a second temperature of the second heating element 110 on a temperature profile in the fluid in the microfluidic system 100, i.e., in the example of the cartridge, when it is controlled according to the control protocol.

In a step 304, the target for the temperature profile is provided. It may be provided that the method will be repeated for different targets. For example, the target is continuously improved based on validation data or adapted to new cartridge designs or assay types.

In a step 306, the parameter set is determined for which a temperature profile calculated with the model 206 fulfills the target specification.

The parameter set comprises at least one parameter of the control protocol that specifies the first temperature and the second temperature. If other heating elements are provided or used, the parameter set in the example also includes respective parameters for them.

Other parameters may also be determined.

For example, a parameter of the control protocol is determined, which specifies an order in the control protocol in which the first chamber 102 and the second chamber 104 are used to influence the temperature of the fluid. If other chambers are provided or used, the parameter set in the example also includes respective parameters for them.

For example, a parameter of the control protocol is determined, which specifies a dwell time of the fluid in the first chamber 102 and/or a dwell time of the fluid in the second chamber 104 in the parameter set.

For example, a parameter of the control protocol is determined which specifies a geometry of at least one of the chambers of the microfluidic system 100 with variable geometry and/or at least one position of at least one of the heating elements of the microfluidic system with variable position in the parameter set.

Optionally, a plurality of candidates for the control protocol can be determined.

It can also be provided to determine at least one parameter of the parameter set with which the temperature influence in the microfluidic system 100 is determined. For example, a parameter of the model 206 is determined that defines a differential equation or a weight of an artificial neural network, or an expected value or variance of a statistical process, in particular a Gaussian process.

For example, by repeating step 306, a plurality of control protocols is determined as candidates, and in an optional step 308, the candidate is selected as the control protocol from the candidates with which the target is achieved faster than with at least one of the other candidates. In the procedure illustrated in the example, step 306 is repeated after step 308. The control protocol is determined in a first iteration and stored as a candidate. In the example, the stored candidate is compared with other candidates that are determined in the following iterations. The candidate selected in a particular iteration is in turn saved and used for comparison with a candidate determined in the next iteration.

It may be provided that the method will end when the optimal candidate is determined. In this case, the method is limited to the simulation. In this case, the control protocol of the optimal candidate is stored, e.g., for application in the microfluidic system 100.

Optionally, after step 308, the microfluidic system 100 is controlled in a step 310 using this control protocol. For example, a control protocol for the microfluidic system 100 is determined using the method described, and the microfluidic system 100 is controlled using the control protocol.

For example, the microfluidic system 100 is controlled with the control protocol to set the first temperature on the first heating element 108. For example, the microfluidic system 100 is controlled with the control protocol to set the second temperature on the second heating element 110.

For example, the microfluidic system 100 is controlled with the control protocol to pneumatically push or suck the fluid into the first chamber, in particular with the first actuator 118 and/or the second actuator 120. In the example, the control protocol specifies the time periods that the fluid remains in the first chamber 102.

For example, the microfluidic system 100 is controlled with the control protocol to pneumatically push or suck the fluid into the second chamber, in particular with the first actuator 118 and/or the second actuator 120. In the example, the control protocol specifies the time periods that the fluid remains in the second chamber 102.

In one example, the control protocol specifies an order in which the fluid moves through these chambers. It may be provided that the parameter that specifies the first temperature is constant during control with the control protocol. It may be provided that the parameter that specifies the first temperature changes during control with the control protocol. For example, respective first temperatures are predetermined for different time periods during which the fluid is to be located in the first chamber 102. It may be provided that the parameter that specifies the second temperature is constant during control with the control protocol. It may be provided that the parameter that specifies the second temperature changes during control with the control protocol. For example, respective second temperatures are predetermined for different time periods during which the fluid is to be located in the second chamber 104.

For a correct biochemical sequence in the case that only the first chamber 102 is provided, a control of the first heating element 108 is provided with the control protocol, which sets a change of the temperature control for the required temperature profile in the sample with the first heating element 108. If two chambers are also provided, proceed accordingly, wherein a change of the temperature control by moving the fluid alternately into one of the two chambers may be provided.

The microfluidic system 100 is controlled in an example with the control protocol to change the geometry of at least one of the chambers.

The microfluidic system 100 is controlled in an example with the control protocol to change the position of at least one of the heating elements.

In the example, the control protocol specifies control signals for the heating elements and/or the actuators and/or the geometry and/or the position. These are determined, for example, by the device 200 and output to control the microfluidic system 100.

Typical biochemical assays determine the target function for the optimization problem in the following form:

Specification of an initial denaturation temperature and associated duration. Specification of temperature intervals and durations for n cycles of denaturation, annealing and elongation, as required, for example, for performing a polymerase chain reaction.

The following table provides an order of steps in an exemplary assay.

| Step | Temperature (° C.) | Time | |
|---|---|---|---|
| Initial denaturation, | 95 | 2 | min |
| Denaturation I | 95 | 30 | sec |
| Annealing I | 63 | 40 | sec |
| Elongation I | 72 | 15 | sec |
| Denaturation II | 95 | 12 | sec |
| Annealing I | 63 | 12 | sec |
| Extension II | 72 | 12 | sec |

After the initial denaturation, 15 cycles I are performed in this example, i.e., denaturation I, annealing I, elongation I. Subsequently, in this example, 25 cycles are performed, i.e. denaturation II, annealing II, elongation II.

In the example, the temperature limits for denaturation are 94° C.-99° C., for annealing 62° C.-64° C. and for elongation 71° C.-73° C.

To achieve the target function defined in this way, the following parameter set is varied in the simulation in the example until at least one solution to the optimization problem is found: Temperature, selection of the chambers used, dwell times in the selected chambers.

A temporal sequence of these parameters represents a control protocol that should run in the microfluidic system 100, e.g., in particular in the cartridge. For example, the control protocol is implemented directly in a system controller of the microfluidic system 100 or the cartridge. For example, the system controller is the device 200 or a separate microprocessor on which the control protocol is or will be implemented.

A parameter set that defines a control protocol includes specific values for these parameters. The variation of these parameters is carried out in the example by a suitable algorithm. It may also be provided that individual or all parameters are proposed to a user for manual modification via a human-machine interface. The model 206 that is parameterized with the parameter set is used to describe the system, i.e., to predict the temporal temperature profile in the sample that occurs when the microfluidic system 100 or the cartridge is controlled by the control protocol.

For the initial parameter set, the dwell times and temperatures are specified in the example, wherein the number of chambers corresponds to the number of different temperature levels of the assay.

If a prediction of the fluid temperature by the model 206 with these parameters shows deviations from the target, automatic or manual empirical corrections are made in the example in accordance with rules for this. Deviations that arise, e.g., due to differences in thermal behavior between the model 206 and the modeled microfluidic system 100 or target cartridge, are eliminated in the example by varying parameters.

Rules for automatic correction or empirical correction are, for example:
If the temperature intervals are too short, the dwell times are increased. If the target temperatures are not reached, e.g., the dwell times are increased and the associated heater temperatures are changed.

Due to the physical coupling between the fluid temperature and the different parameters, there may be mutual compensation or amplification of parameter influences. Additional corrections will be made for these.

During several such iterations, the corrections will gradually decrease until convergence is achieved.

The model 206 may comprise at least one of the following models:

It may be provided that the model 206 comprises a 3D model designed to determine the first temperature as a function of the control protocol and as a function of a temporal and spatially discretized calculation of heat and material transfer in the microfluidic system 100 or in the cartridge. The 3D model preferably represents the actual structure of the part of the microfluidic system 100 to be modeled, in particular the structure and material properties of the chambers and heating elements to be modeled. For example, the control protocol is used in the boundary and initial conditions for the 3D model. The temperature profile is a computational result obtained when calculating the 3D model.

For the 3D model, the enthalpy equation (1) may be spatially discretized by finite volumes or finite elements, provided that the geometrical features and physical gradients are resolved. The same applies to the temporal discretization, which must allow time changes in the system to be followed. In this case, the Fourier thermal equation for the temperature field T is solved in the partial volumes Ωᵢ\Σᵢ (subdivided by inner cutting surfaces Σᵢ and each with density ρ, specific heat capacity cₚ and thermal conductivity λ):

$${\partial }_{t} ( ρ {c}_{p} T ) = ∇ \cdot ( λ ∇ T ) in {Ω}_{i} ∖ {\sum }_{i} \qquad ( 1 )$$

$$〚 T 〛 = 0 ⋂ 〚 λ ∇ T 〛 \cdot {n}_{i} = 0 on {\sum }_{i} \qquad ( 2 )$$

It should also be noted that the continuity of the temperature and the heat flows must be maintained at the physical domain boundaries (equation (2)). The heater temperatures are predetermined as time-dependent Dirichlet boundary conditions.

It may be provided that the model 206 comprises a network model, also referred to as the thermal network model, which is designed to determine the first temperature depending on the control protocol by linking relevant states, which are represented by simplified equations for heat and mass transfer in the microfluidic system 100 or in the cartridge. For example, a physically based abstraction of the 3D model is used as a network model, wherein the concrete relationships between heat capacities and thermal resistances are arranged in the form of a network using the analogies of voltage to temperature and current to heat flow according to its name. For example, the control protocol is used in the activation signals and initial conditions for the network model. The temperature profile is a computational result obtained when calculating the network model. The mathematical form of the equation system depicted in the network model is given by equation (3):

$$( \begin{matrix}{C}_{1} & ⋯ & 0 \\ ⋮ & ⋱ & ⋮ \\ 0 & ⋯ & {C}_{n}\end{matrix} ) ( \begin{matrix}{\dot{T}}_{1} \\ ⋮ \\ {T}_{n}\end{matrix} ) = ( \begin{matrix}- ( \frac{1}{{R}_{12}} + ⋯ + \frac{1}{{R}_{1 m}} ) & \frac{1}{{R}_{12}} & ⋯ & ⋯ & ⋯ & \frac{1}{{R}_{1 m}} \\ \frac{1}{{R}_{21}} & - ( \frac{1}{{R}_{21}} + \frac{1}{{R}_{23}} + ⋯ + \frac{1}{{R}_{2 m}} ) & ⋯ & ⋯ & ⋯ & \frac{1}{{R}_{2 m}} \\ ⋮ & ⋮ & ⋯ & ⋯ & ⋯ & ⋮ \\ \frac{1}{{R}_{n 1}} & \frac{1}{{R}_{n 2}} & ⋯ & - ( \frac{1}{{R}_{n 1}} + ⋯ + \frac{1}{{R}_{nm}} ) & ⋯ & \frac{1}{{R}_{nm}}\end{matrix} \qquad ( 3 )$$

This is a linear, ordinary first-order differential equation system for the temperatures Tᵢ at various locations i in the microfluidic system 100 or in the cartridge. The parameters that occur are the heat capacities Cᵢ=(cₚρV)ᵢ with the specific heat capacity of the material in the vicinity of the point i, the density of the material ρ and the volume V associated with the point i. Furthermore, the

$${R}_{ij} = \frac{{l}_{ij}}{{λ}_{ij} {A}_{ij}}$$

denotes the thermal resistances between the points i, j, wherein l denotes the point spacing, λᵢⱼ the thermal conductivity of the material between the points i, j and Aᵢⱼ the contact area between the volumes associated with the points i, j. The temperatures Tₙ₊₁ to Tₘ correspond to the predetermined heater temperatures.

It may be provided that the model 206 comprises a data-based model that is trained by training data from the 3D model or experimental temperature measurements to predict the first temperature depending on the control protocol. For example, the data-based model is an artificial neural feedforward network. For example, the data-based model is designed to predict the temporal change in temperature based on the current temperature conditions.

A combination of these models may also be provided.

A combination of different models is used, for example, if a single model does not adequately accurately depict all relevant correlations. Individual models then model parts of the relevant relationships.

For example, movements of the fluid are determined with the 3D model and thermal effects in the solid body of the microfluidic system 100 or the cartridge with the network model. This reduces computational effort.

It may be provided that unknown material parameters are determined with a data-based model as a function of training data from experiments and used in one of the other models, i.e., the 3D model or the network model.

The network model and the data-based model have the advantage of low computational effort for the evaluation compared to the 3D model for the same calculation. This accelerates the described parameter variations. The network model may be created independent of the 3D model. However, the network model is inferior to the 3D model in terms of accuracy. An accuracy of the data-based model depends on an accuracy of the data used in the training.

For example, the time series calculated by the 3D model and/or the network model are used along with the control signals for data-based system identification.

For thermal effects, for example, a time behavior of the temperature in the fluid at a fixed fluid position is described with sufficient accuracy by a time invariant, linear system of ordinary differential equations.

A change of the dwell chambers, i.e., a movement of the fluid from one of the chambers to another of the chambers, may be depicted either by time-dependent coefficients of this system or by a discrete or continuous change between multiple equation systems. Each of the latter equation systems corresponds to a fluid position/configuration.

The calculated time series represent the training data. In the example, the training data is used to determine the coefficients of the linear differential equations by minimizing an error between a predicted system response and a system response described by the training data.

To this end, one of the following several possibilities is used: the method of the least squares over all data points of the training data, the training of a neural network containing the system coefficients.

It may also be provided to evaluate a training success in addition to reproducing the training data using pre-calculated system responses.

The target is in one example a target function, the target intervals, i.e. target time intervals and target temperature intervals. The models described provide time series, e.g., a fluid temperature as a function of time. In the example, these time series are matched with the target function. For example, those actual time intervals are determined in which the fluid temperature is within a target temperature interval associated with the respective target time interval. For this purpose, the time series is run through from the beginning, and for each point in time it is checked whether, and if so, at which target temperature interval the temperature lies. If a temperature value of the temperature is within the temperature interval associated with this target time interval, then the temperature values at subsequent points in times are added to an actual time interval as long as they are continuously within the same target temperature interval, otherwise the actual time interval is ended. The actual time interval length is determined depending on a difference between the end and start times of those temperature values that were in the target temperature interval. The order of actual time intervals and the actual time interval lengths are compared in the example with the target time intervals and their target time interval length. If there is a deviation between them, corrections are made to the parameters of the control protocol.

This operation is repeated in the example.

In this process, either an expert or an algorithm determines the parameters with the goal of minimizing the deviation.

Suitable target functions can also be used to achieve a time-optimal solution, i.e., a fast process.

Examples of the algorithm are provided below. The algorithms differ in terms of the solution space examined and/or in the quality of the solution found.

Random search: By randomly scanning the parameter space, a solution is found that fulfills a termination criterion, in the example the target.

Bayesian optimization: The influence of the parameters on the target function is sampled by a learning algorithm, learned, and used to suggest the best solution. New parameter sets are thereby generated based on the probability distribution learned and a heuristic function, e.g., the acquisition function. The currently assumed optimum is used for this purpose, for example.

Model predictive control: During the solution of a differential equation system comprising the model 206, the control parameters are dynamically adjusted by pre-calculating a certain amount of time into the future and evaluating the influence of the parameters based thereon.

FIG. 4 shows an exemplary temperature profile in the fluid 402 under the influence of a first temperature profile 404 in the first chamber 102, a second temperature profile 406 in the second chamber 104, and a third temperature profile 408 in the third chamber 106 over time, for example for performing a polymerase chain reaction at three different temperature levels. As a result of fluid movement between the chambers due to the control protocol, the fluid is located in different chambers over time. A first fluid temperature 410 predicted by the model 206 for the first chamber 102, a second fluid temperature 412 predicted by the model 206 for the second chamber 104, and a third fluid temperature 414 predicted by the model 206 for the third chamber 106 are each shown as curve segments in FIG. 4. The fluid heats up while dwelling in the first chamber 102 according to the predicted first fluid temperature 410 and cools while dwelling in the third chamber 106 according to the predicted third fluid temperature 414, as a temperature in the third chamber 106 is less than a temperature in the first chamber 102 in the example. The first fluid temperature 410 predicted by the model 206 deviates from this after reaching a maximum temperature in the temperature profile 402. The third fluid temperature 414 predicted by the model 206 deviates from this after reaching a minimum temperature in the temperature profile 402. In the example, the fluid also dwells in the second chamber 104, wherein the temperature in the second chamber 104 is between the temperature in the third chamber 106 and the temperature in the first chamber 104. In the example, the fluid reaches the predicted second fluid temperature 412, in the example the temperature at which the second chamber 104 is heated, at the end of the temperature profile 402, while dwelling in the second chamber 104.

FIG. 5 schematically illustrates an exemplary sequence control 500 over time. In the example, the sequence control 500 is performed with the control protocol in which the fluid alternately dwells in the first chamber 102 and the third chamber 106, and in the second chamber 104 in between, wherein the fluid is in the second chamber 104 at the end and the temperature profile in the fluid 402 is set.

FIG. 6 shoes a course of a fluid temperature 602 with a temperature target corridor 604 and a target 606 for an example calculation with a Bayesian optimization for a simulation time of 150 seconds. In the example, the temperature target corridor is predetermined by the temperature limits.

FIG. 7 shows a course of temperatures and dwell times of the fluid in the example calculation. The upper graph shows a course of a first temperature 702 of the first heating element 108, a course of a second temperature 704 of the second heating element 110, and a course of a third temperature 706 of the third heating element 112 over time. The lower graph shows whether the fluid dwells in the first chamber 102, the second chamber 104 and the third chamber 106 with a value of 1. A value of 0 means the fluid is not in the respective chamber.

The example calculation provides that the temperatures of the heating elements are initially determined randomly and then kept constant during the example calculation. In the example, the fluid position is changed within the simulation time of 150 s, depending on whether the fluid temperature is in the target corridor or not. In the example, a chamber change takes place as soon as the fluid has been in a temperature target corridor for long enough, i.e., the time defined by the target.

The control protocol with which this temperature profile is set is used. e.g., for microfluidic lab-on-chip systems for medical diagnostics, in particular for biochemical processing by means of temperature profiles.

1. A computer-supported method for determining a control protocol for a microfluidic system using temperature influences, wherein the microfluidic system comprising a first chamber for a fluid, and a first heating element for influencing a temperature of the fluid in the first chamber, the method comprising:
providing a model parameterized with a parameter set, and configured to determine an influence of a first temperature and an influence of a second temperature on a temperature profile in the fluid in the microfluidic system, if same is controlled according to the control protocol;
providing a target for the temperature profile; and
determining the parameter set at which the temperature profile calculated with the model fulfills the target,
wherein the parameter set comprises at least one parameter of the control protocol which specifies the first temperature and/or the second temperature.

2. The method according to claim 1, wherein:
the microfluidic system comprises a second chamber for the fluid, and a second heating element configured to influence the temperature of the fluid in the second chamber, and
the model determines an influence of the first temperature of the first heating element and an influence of the second temperature of the second heating element on the temperature profile in the fluid in the microfluidic system.

3. The method according to claim 2, further comprising:
determining at least one parameter of the parameter set, which specifies an order in the control protocol in which the first chamber and/or the second chamber are used to influence the temperature of the fluid.

4. The method according to claim 2, further comprising:
determining at least one parameter of the parameter set, which specifies a dwell time of the fluid in the first chamber and/or a dwell time of the fluid in the second chamber in the control protocol.

5. The method according to claim 1, further comprising:
determining a plurality of candidates for the control protocol; and
selecting the candidate as the control protocol from the candidates, with which the target is achieved faster than with at least one of the other candidates.

6. The method according to claim 1, further comprising:
determining at least one parameter of the parameter set, which specifies a geometry of at least one chamber of the microfluidic system with variable geometry and/or at least one position of the first heating element of the microfluidic system with variable position in the control protocol.

7. The method according to claim 1, further comprising:
determining at least one parameter of the parameter set with which the temperature influence in the microfluidic system is determined.

8. The method according to claim 2, further comprising:
determining the control protocol for the microfluidic system; and
controlling the microfluidic system using the control protocol.

9. The method according to claim 8, further comprising:
controlling the microfluidic system with the determined control protocol to set the first temperature on the first heating element and/or to set the second temperature on the second heating element.

10. The method according to claim 8, further comprising:
controlling the microfluidic system with the determined control protocol to pneumatically push or suck the fluid into at least one chamber.

11. The method according to claim 8, further comprising:
controlling the microfluidic system with the determined control protocol to change the geometry of at least one chamber, and/or to change the position and/or the temperature of at least one heating element.

12. A device comprising:
at least one processor; and
at least one memory,
wherein the at least one processor is configured to perform the method according to claim 1.

13. The device according to claim 12, further comprising:
the microfluidic system.

14. The method according to claim 1, wherein a computer program comprises computer-readable instructions that, when executed by a computer, cause the method to run.
